(19) United States
(12) Patent Application Publication
(10) Pub. No.: US 2011/0196636 A1
(43) Pub. Date: Aug. 11, 2011

(54) MEASUREMENT METHOD FOR A COMPONENT OF THE GRAVITY VECTOR

(75) Inventor: Carl M. Edwards, Katy, TX (US)

(73) Assignee: BAKER HUGHES INCORPORATED, Houston, TX (US)

(21) Appl. No.: 13/016,109

(22) Filed: Jan. 28, 2011

Related U.S. Application Data
(60) Provisional application No. 61/301,026, filed on Feb. 3, 2010.

(51) Int. Cl. G01C 25/00

(52) U.S. Cl. 702/92

(57) ABSTRACT

The present disclosure relates to methods and apparatuses for calibrating a sensor, particularly a gravimeter, which involves positioning the sensor in at least three different orientations and calibrating the sensor using a linear model and the sensor outputs from the at least three different orientations. The method may include applying an external force to the sensor. The apparatus includes a processor and storage subsystem with a program that, when executed, implements the method.

### CROSS-REFERENCES TO RELATED APPLICATIONS

This application claims priority from U.S. Provisional Patent Application Ser. No. 61/301,026 filed on 3 Feb. 2010.

### FIELD OF THE DISCLOSURE

In one aspect, the present disclosure generally relates to methods and apparatuses for calibrating sensors, including, but not limited to, relative gravimeters.

### BACKGROUND OF THE DISCLOSURE

Many factors, such as environmental conditions, wear, and time, may cause sensors to become misaligned or require calibration or adjustment. An uncalibrated or miscalibrated sensor may provide false readings, malfunction, or cease to function. When this happens, calibration may be required, which can result in expenditures of time and money and possibly risk to personnel involved in the calibration process, particularly when a sensor is located in a hostile environment.

### SUMMARY OF THE DISCLOSURE

In aspects, the present disclosure is related to a method and apparatus for calibrating a sensor, which involves moving the sensor from an initial orientation to at least two different orientations.

One embodiment according to the present disclosure includes a method for calibrating a sensor, comprising: moving the sensor to at least two different orientations, wherein the sensor has an initial orientation; and calibrating the sensor with a linear model using information acquired from the initial orientation and the at least two different orientations, wherein the information includes a response by the sensor to earth gravity and an external force.

Another embodiment according to the present disclosure includes an apparatus for calibrating a sensor, comprising: a processor; a storage subsystem; and a program stored by the storage subsystem comprising instructions that, when executed, cause the processor to: move the sensor to at least two different orientations, estimate a gain factor based on information acquired from an initial orientation of the sensor and the at least two different orientations, wherein the information includes a response by the sensor to earth gravity and an external force, and estimate, an offset based on information acquired from an initial orientation of the sensor and the at least two different orientations.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a measurement device deployed along a wireline according to one embodiment of the present disclosure;

FIG. 2 shows an orientation framework for one embodiment according to the present disclosure;

FIG. 3 illustrates one coordinate framework according to one embodiment of the present disclosure; and

FIG. 4 shows schematic of the apparatus for implementing one embodiment of the method according to the present disclosure.

### DETAILED DESCRIPTION

The present disclosure relates to methods and apparatuses for calibrating a sensor, particularly a gravimeter, which involves positioning the sensor in at least three different orientations and calibrating the sensor using a linear model and the sensor outputs while the sensor is in the at least three different orientations. The method may include applying an external force to the sensor.

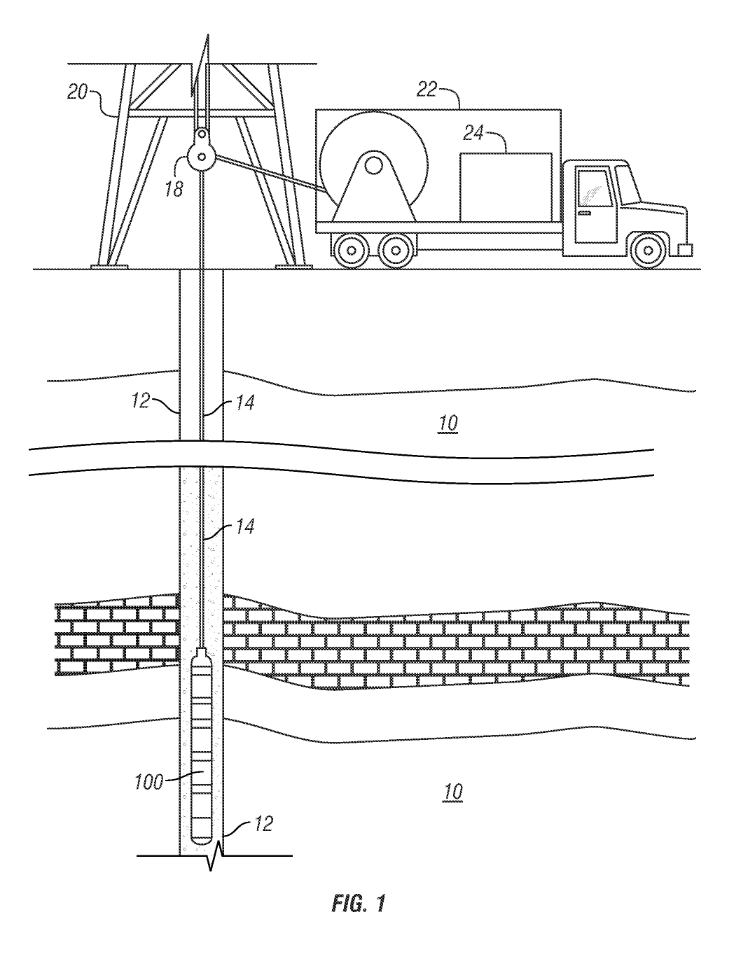

FIG. 1 shows one embodiment according to the present disclosure wherein a cross-section of a subterranean formation 10 in which is drilled a borehole 12 is schematically represented. Suspended within the borehole 12 at the bottom end of a non-rigid carrier such as a wireline 14 is a sensor 100. The wireline 14 may be carried over a pulley 18 supported by a derrick 20. Wireline deployment and retrieval is performed by a powered winch carried by a service truck 22, for example. A control panel 24 interconnected to the sensor 100 through the wireline 14 by conventional means controls transmission of electrical power, data/command signals, and also provides control over operation of the components in the measurement device 100. In some embodiments, the borehole 12 may be utilized to recover hydrocarbons. In other embodiments, the borehole 12 may be used for geothermal applications or other uses. In some embodiments, the sensor 100 may also be located on the surface, near the top of the borehole 12. Exemplary sensors may include relative gravimeters, accelerometers, magnetometers, and electric field meters.

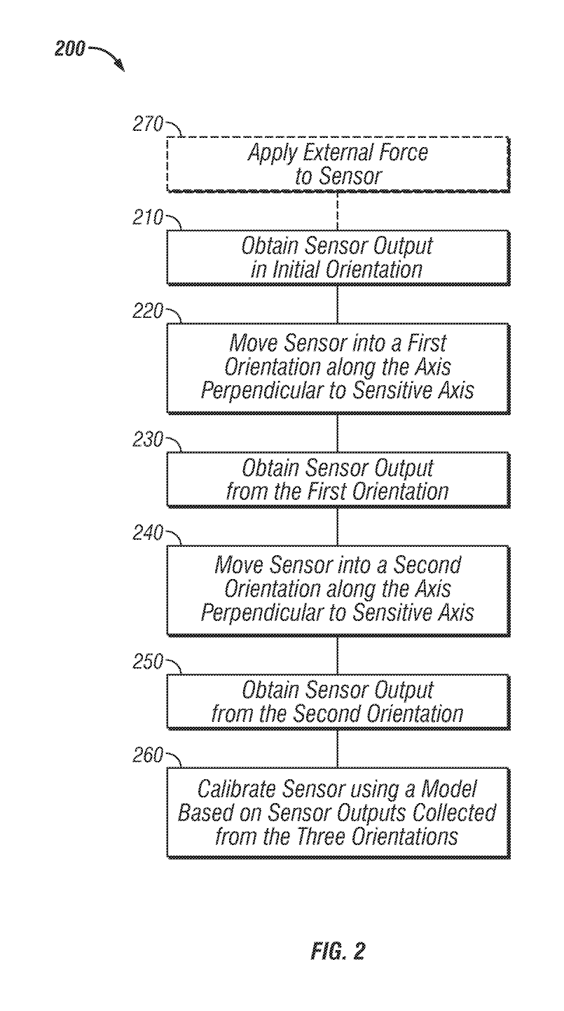

As shown in FIG. 2, one embodiment includes a method 200 according to the present disclosure, for calibrating the sensor 100. Method 200 includes step 210, where the sensor output may be obtained for an initial orientation. The calibration process may use three or more orientations of the sensor 100; however, the number of orientations may be reduced if the initial orientation of the sensor 100 is used as one of the three or more orientations. In step 220, the sensor 100 may be moved from an initial orientation to the first of at least two different orientations, which may be described in terms of their angular displacement along an axis of rotation that is perpendicular to the sensitive axis of the sensor 100. For the purpose of discussion, the sensitive axis will be referred to as the z-axis and the axis of rotation will be referred to as the x-axis. This convenient assignment of axes in no way limits which axes may be used with embodiments of the present disclosure. The sensitive axis is the axis along which the sensor 100 may be intended to provide measurement once the sensor 100 is calibrated.

After movement to the first orientation, the sensor output may be obtained in step 230. In step 240, the sensor 100 may be moved into the second of at least two different orientations. In step 250, the sensor output may be obtained for the second orientation. At this point, sensor outputs have been obtained for three different orientations. This is illustrative and exemplary only, as the method may use more than three different orientations and it is not necessary that one of the orientations be the initial orientation of the sensor 100.

In step 260, the sensor may be calibrated using a linear model based on the sensor outputs obtained during the three or more orientations. While the sensor 100 has been oriented, the sensor 100 may have been exposed to additional forces, such as earth tidal force. This earth tidal force may be used in the calibration process. Calibration may also use sensor outputs obtained while the sensor 100 was exposed to a known external force that is artificially imposed on the sensor 100. Method 200 may be performed during the actual measurement process, such that measurement and calibration may occur simultaneously and may not require previous knowledge of the gravitational force where the sensor 100 may be located.

When an optional external force is used in the calibration process, then, in step 270, the external force may be applied to the sensor 100. In some embodiments, the optional external force may be on the order of 1/100 to 1/1000 times the force of earth gravity.

In one embodiment of the method, the model used may include a gain or scale factor as an output. Determining the gain may involve using information obtained when applying an external force to the sensor that is distinct from a force to be measured along a sensitive axis. Herein, the term “information” may include, but is not limited to, one or more of: (i) raw data, (ii) processed data, and (iii) signals. The gain may be determined by using a change in sensor output between before and after the external force is applied. The gain factor may be estimated using a mathematical fitting technique, such as, but not limited to, least-square fit.

Using the gain factor, the information from the sensor orientations may be mathematically fitted (such as least-square fit) to determine an estimate of the offset. An estimate of the force along the sensitive axis may also be obtained at this time.

In the present disclosure, the axis of rotation is a way of measuring the angular difference between references within the coordinate system and the orientation of the sensor, and the word rotation does not imply that the disclosure requires a device or components for rotating in a mechanical sense, since moving the sensor to new orientations (not necessarily rotating through angles) is all that is required for the calibration to take place.

In one embodiment, the sensor may be a gravity sensor or gravimeter, such as a relative gravimeter. In this embodiment, the sensitive axis may be the axis designated to measure the force of earth gravity, and the axis of rotation may taken from any axis perpendicular to the earth gravity vector.

In order to calibrate a gravity sensor of any kind it is helpful to use a known input and measure the output of the sensor. Typically, gravity sensors are high precision instruments, and it may be assumed that the input to a gravity sensor be known with great precision. Assuming a linear output, the output of a gravity sensor may be represented by the formula:

γ=Ag_{z}+b (1)

where γ is the output of the gravity sensor, A is a gain or scale factor, b is an offset, and g, is the component of the gravity vector projected on to the sensitive axis of the gravity sensor. When calibrating over a small portion of the total range of the sensor, it may be assumed that the entire calibration is piecewise linear and equation (1) is valid. Because of the extreme sensitivity of the gravity sensor, 1 ppb, it may be assumed that A and b are both temperature and time dependent.

### Determining the Gain Using an External Force

One alternative, though not limiting, to determine the gain is the use of an external force on the gravity sensor. When the external force, f, is applied, equation (1) becomes

γ=A(g_{z}+f)+b (2)

Rearranging this expression,

γ=Af+(Ag_{z}+b) (3)

it becomes clear that a least-square fit to a set of inputs and output will yield A and (Ag_{z}+b). Alternatively, cos β may be extracted by combining the use of earth tides with the external force.

As an example, two known and precise external forces, f₁ and f₂, may be applied to the gravity sensor, where one of the forces may be equal to zero. This results in equation (3) becoming:

γᵢ=Afᵢ+(Ag_{z}+b);iε{1,2} (4)

### Solving for A,

$$A = \frac{{γ}_{2} - {γ}_{1}}{{f}_{2} - {f}_{1}} \qquad ( 5 )$$

The quantity b may not be estimated yet while g_{z} is unknown. The estimate of A may be improved by using N external forces on the gravity sensor. A may then be estimated using a linear least-square fit, as follows in equation (6):

$${A}^{- 1} = \frac{1}{Δ} ( {\sum }_{i} {γ}_{i}^{2} {\sum }_{i} {f}_{i} - {\sum }_{i} {γ}_{i} {\sum }_{i} {γ}_{i} {f}_{i} ) \\ Δ = {\sum }_{i} {f}_{i}^{2} - {( {\sum }_{i} {f}_{i} )}^{2} \qquad ( 6 )$$

In the alternative, when the dominant error may be independent of the external force, an estimate A may be estimated using the equation:

$${A}^{- 1} = \frac{1}{Δ} ( {\sum }_{i} {γ}_{i}^{2} {\sum }_{i} {f}_{i} - {\sum }_{i} {γ}_{i} {\sum }_{i} {γ}_{i} {f}_{i} ) \\ Δ = {\sum }_{i} {γ}_{i}^{2} - {( {\sum }_{i} {γ}_{i} )}^{2} \qquad ( 7 )$$

### Rotating the Sensor

At this point, with a value for A, the offset, b, may be estimated. Since the calibration may be performed in-situ, the method may provide for calibration while the sensor simultaneously remains sensitive to a component of gravity. As such, the input may not be merely set to zero to obtain an estimate for the offset. The offset may be determined by varying the value of g_{z} by different techniques including, but not limited to, rotating the sensor and accelerating the sensor.

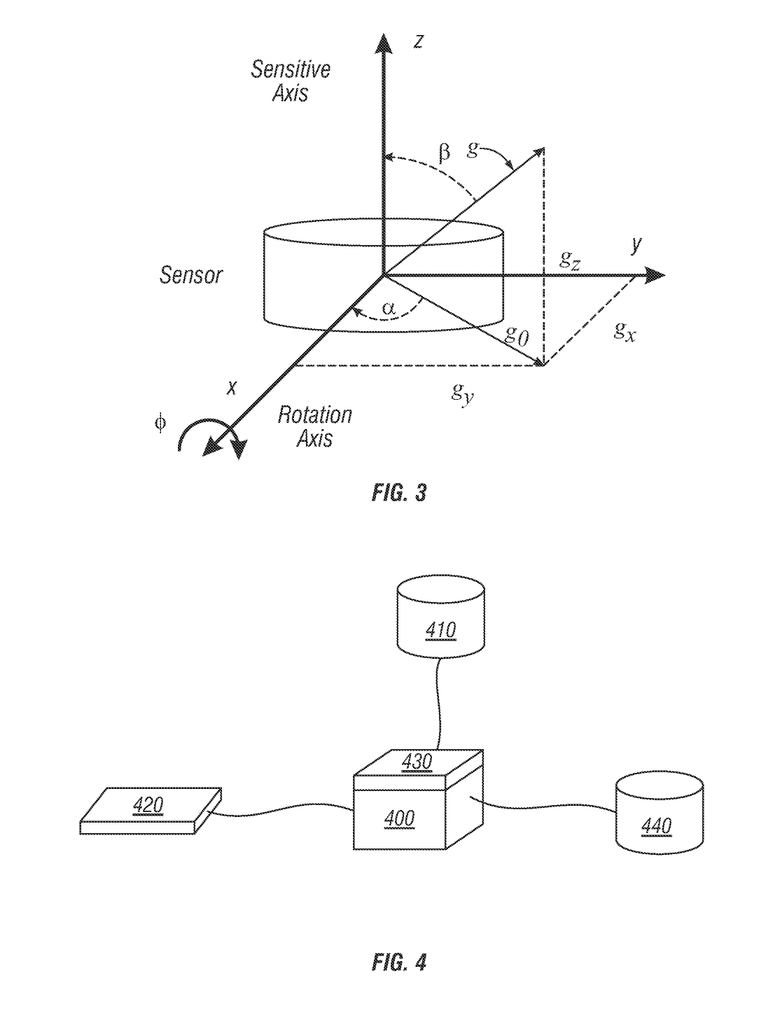

Applying a coordinate system using the sensitive axis as the z-axis, the sensor may be rotated around or positioned along either axis that is perpendicular to the z-axis. For convenience of this example, the x-axis will be a rotational axis, however, the y-axis is suitable as well. If multiple sensitive axes are possible, the z-axis and x-axis may be changed as necessary for calibration in multiple dimensions. This may be performed as long as the axis for moving the sensor is perpendicular to the sensitive axis. This coordinate system is illustrated in FIG. 3.

With the z-axis and x-axis assigned, equation (1) may become

γ=A\hat{z}·g+b (8)

where

\hat{z}=(0,0,1)^{T};g=(gₓ,g_{y},g_{z})^{T} (9)

Rotating the sensor has the same effect as rotating the gravity vector through the same angle in the opposite direction. The rotation matrix may be expressed as:

$$R = ( \begin{matrix}1 & 0 & 0 \\ 0 & cos φ & - sin φ \\ 0 & sin φ & cos φ\end{matrix} ) \qquad ( 10 )$$

The force of gravity may also be expressed as follows:

g=(gₓ,g₀ sin α,g₀ cos α)^{T};

tan α=g_{y}/g_{z}

g₀=\sqrt{g_{y}²+g_{z}²} (11)

where α is the angle of gₒ relative to the x-axis in the plane perpendicular to the z-axis.

So equation (8) becomes

$$\begin{matrix}γ = A {\hat{z}}^{T} Rg + b \\ = A ( \begin{matrix}0 , & 0 , & 1\end{matrix} ) ( \begin{matrix}1 & 0 & 0 \\ 0 & cos φ & - sin φ \\ 0 & sin φ & cos φ\end{matrix} ) ( \begin{matrix}{g}_{x} \\ {g}_{0} sin α \\ {g}_{0} cos α\end{matrix} ) + b \\ = {Ag}_{0} ( cos φ cos α + sin φ sin α ) + b\end{matrix} \qquad ( 12 )$$

For a sensor that is linear over its entire range, b may be determined with equations (13) and (14). The case of α=π is a simple example. Then we have

γ|_{φ=π}=−Ag₀ cos α+b;

γ|_{φ=0}=Ag₀ cos α+b (13)

Then

γ|_{φ=0}+γ|_{φ=π}=2b

γ|_{φ=0}−γ|_{φ=π=}2Ag₀ cos α (14)

So b may be extracted by this simple example.
However, many sensors, including gravity sensors, may not be linear over their entire range.

### Polynomial Fit to Calibration Data

The offset, b, may be determined for a sensor that is not linear over its entire range by performing a mathematical fitting operation to the calibration information. Sensor output information from the at least three different orientations to estimate the offset value.

When the sensor is moved to at least two new orientations that have only a small angular difference from the initial orientation, equation (12) may be expanded to the first order in terms of φ.

$$\begin{matrix}γ = {Ag}_{0} ( cos α + φ sin α ) + b \\ = ( {Ag}_{0} sin α ) φ + ( {Ag}_{0} cos α + b ) .\end{matrix} \qquad ( 15 )$$

It will be clear to one of skill in the art that a linear fit to equation (15) will provide estimates of Ag₀ sin α and Ag₀ cos α+b, however, estimating b may require expanding equation (15) to take into account second order terms. It may be desirable to select a value for φ that is sufficiently large so as to mitigate the effects of noise on output γ.

The orientation of the sensor may be changed by an angle sufficiently large that second order terms may be taken into account as will be understood by one of skill in the art. Then equation (15) becomes

$$\begin{matrix}γ = {Ag}_{0} ( cos α ( 1 - {φ}^{2} / 2 ) + φ sin α ) + b \\ = ( - \frac{{Ag}_{0} cos α}{2} ) {φ}^{2} + ( {Ag}_{0} sin α ) φ + ( {Ag}_{0} cos α + b ) .\end{matrix} \qquad ( 16 )$$

Fitting equation (16) to a quadratic equation in φ with coefficients aₙ, results in:

$${a}_{0} = {Ag}_{0} cos α + b ; \\ {a}_{1} = {Ag}_{0} sin α ; \\ {a}_{2} = - \frac{{Ag}_{0} cos α}{2} . \qquad ( 17 )$$

With these coefficients, we may estimate b as well as other quantities.

b=a₀+2a₂;

tan α=−a₁/2a₂;

g₀=A⁻¹\sqrt{a₁²+(2a₂)²};

g_{z}=−2A⁻¹a₂ (18)

Rewriting equation (16) in terms of the coefficients, aₙ,

γ=a₂φ²+a₁φ+a₀ (19)

With γ as a function of the angle that the sensor is moved along the axis of rotation, the function is a second order polynomial with three unknown constant coefficients, a₀, a₁, and a₂. The three orientations (the initial orientation and the at least two different orientations) provide three data point pairs {φᵢ, γᵢ} that may be expressed as:

γ₁=a₂φ₁²+a₁φ₁+a₀;

γ₂=a₂φ₂²+a₁φ₂+a⁰;

γ₃=a₂φ₃²+a₁φ₃+a₀,

or

γ=Φa (20)

$$γ = {( {γ}_{1} , {γ}_{2} , {γ}_{3} )}^{T} ; a = {( {a}_{0} , {a}_{1} , {a}_{2} )}^{T} ; Φ = ( \begin{matrix}1 & {φ}_{1} & {φ}_{1}^{2} \\ 1 & {φ}_{2} & {φ}_{2}^{2} \\ 1 & {φ}_{3} & {φ}_{3}^{2}\end{matrix} ) \qquad ( 21 )$$

Where Φ is non-degenerate so a solution exists as:

a=Φ⁻¹γ (22)

Which may be expressed in terms of determinants as:

$${a}_{0} = \frac{1}{{Δ}_{a}} \vert \begin{matrix}{γ}_{1} & {φ}_{1} & {φ}_{1}^{2} \\ {γ}_{2} & {φ}_{2} & {φ}_{2}^{2} \\ {γ}_{3} & {φ}_{3} & {φ}_{3}^{2}\end{matrix} \vert ; {a}_{1} = \frac{1}{{Δ}_{a}} \vert \begin{matrix}1 & {γ}_{1} & {φ}_{1}^{2} \\ 1 & {γ}_{2} & {φ}_{2}^{2} \\ 1 & {γ}_{3} & {φ}_{3}^{2}\end{matrix} \vert ; \\ {a}_{2} = \frac{1}{{Δ}_{a}} \vert \begin{matrix}1 & {φ}_{1} & {γ}_{1} \\ 1 & {φ}_{2} & {γ}_{2} \\ 1 & {φ}_{3} & {γ}_{3}\end{matrix} \vert ; {Δ}_{a} = \frac{1}{{Δ}_{a}} \vert \begin{matrix}1 & {φ}_{1} & {φ}_{1}^{2} \\ 1 & {φ}_{2} & {φ}_{2}^{2} \\ 1 & {φ}_{3} & {φ}_{3}^{2}\end{matrix} \vert . \qquad ( 23 )$$

The estimates of aₙ may then be used in equation (18) along with the estimate of A from equations (5), (6), or (7) to estimate b, a and desired gravitational component g_{z}. Estimates for the constant coefficients of equation (19) may be improved by using a larger number of data points. Using N data points:

$$γ = {( {γ}_{1} , {γ}_{2} , … {γ}_{N} )}^{T} ; Φ = ( \begin{matrix}1 & {φ}_{1} & {φ}_{1}^{2} \\ 1 & {φ}_{2} & {φ}_{2}^{2} \\ ⋮ & ⋮ & ⋮ \\ 1 & {φ}_{N} & {φ}_{N}^{2}\end{matrix} ) \qquad ( 24 )$$

Provides an unweighted least-square solution

Σ²=(γ−Φa)^{T}(γ−Φa) (25)

which may be minimized with respect to vector a resulting in:

a=(Φ^{T}Φ)⁻¹Φ^{T}γ (26)

The above optimization is illustrative and exemplary only, as other optimization techniques known to those of skill in the art may be used to obtain estimates for the constant coefficients of equation (19).

### Trigonometric Fit to Data

One alternative way to fit the data is to use a trigonometric fit. Equation (12) may be modified for the cosine and sine functions.

γ=a_{c} cos φ+aₛ sin φ+b;

a_{c}=Ag₀ cos α;

aₛ=Ag₀ sin α;

tan α=aₛ/a_{c};

g₀=A⁻¹\sqrt{aₛ²+a_{c}²};

g_{z}=A⁻¹a_{c} (27)

This is still a linear fit but uses a different coordinate system from the polynomial fit and has better accuracy because all the terms in the expansion of the sine and cosine are taken into account. The g_{z}(=g₀ cos α) component falls naturally out of the estimate of a_{c}.

Equation (27) may be rewritten in terms of a matrix for N points, γ=Tq;

$$γ = {( {γ}_{1} , {γ}_{2} , … , {γ}_{N} )}^{T} ; q = {( {q}_{1} , {q}_{2} , {q}_{3} )}^{T} = {( b , {q}_{c} , {q}_{s} )}^{T} ; \\ T = ( \begin{matrix}1 & cos {φ}_{1} & sin {φ}_{1} \\ 1 & cos {φ}_{2} & sin {φ}_{2} \\ ⋮ & ⋮ & ⋮ \\ 1 & cos {φ}_{N} & sin {φ}_{N}\end{matrix} ) \qquad ( 28 )$$

Using at least three data point pairs {φᵢ,γᵢ} to estimate q, which may include information obtained from the initial orientation and the at least two different orientations, pairs may be written as:

γ₁=q₃ sin φ₁+q₂ cos φ₁+q₁;

γ₁=q₃ sin φ₂+q₂ cos φ₂+q₁;

γ₁=q₃ sin φ₃+q₂ cos φ₃+q₁ (29)

As matrix T is non-degenerate within a rotational angle range (−π, +π), a solution exists for N=3 as:

q=T⁻¹γ (30)

which may be expressed in terms of determinants as:

$${q}_{1} = \frac{1}{{Δ}_{q}} \vert \begin{matrix}{γ}_{1} & cos {φ}_{1} & sin {φ}_{1} \\ {γ}_{2} & cos {φ}_{2} & sin {φ}_{2} \\ {γ}_{3} & cos {φ}_{3} & sin {φ}_{3}\end{matrix} \vert ; {q}_{2} = \frac{1}{{Δ}_{a}} \vert \begin{matrix}1 & {γ}_{1} & sin {φ}_{1} \\ 1 & {γ}_{2} & sin {φ}_{2} \\ 1 & {γ}_{3} & sin {φ}_{2}\end{matrix} \vert ; \\ {q}_{3} = \frac{1}{{Δ}_{a}} \vert \begin{matrix}1 & cos {φ}_{1.} & {γ}_{1} \\ 1 & cos {φ}_{2 :} & {γ}_{2} \\ 1 & cos {φ}_{3 :} & {γ}_{3}\end{matrix} \vert ; {Δ}_{q} = \frac{1}{{Δ}_{q}} \vert \begin{matrix}1 & cos {φ}_{1} & sin {φ}_{1} \\ 1 & cos {φ}_{2} & sin {φ}_{2} \\ 1 & cos {φ}_{3} & sin {φ}_{3}\end{matrix} \vert . \qquad ( 31 )$$

The estimates of q may then be used in equation (27) along with the estimate of A from equations (5), (6), or (7) to estimate b, a and desired gravitational component g_{z}. Estimates for the constant coefficients of equation (28) may be improved by using a larger number of data points. With N data points an unweighted least-square solution

Σ²=(γ−Tq)^{T}(γ−Tq) (32)

may be minimized with respect to vector q resulting in:

a=(T^{T}T)⁻¹T^{T}γ (33)

The above optimization is illustrative and exemplary only, as other optimization techniques known to those of skill in the art may be used to obtain estimates for the constant coefficients of equation (28).

As shown in FIG. 4, certain embodiments of the present disclosure may be implemented with a hardware environment that includes an information processor 400, an information storage medium 410, an input device 420, processor memory 430, and may include peripheral information storage medium 440. The hardware environment may be in the well, at the rig, or at a remote location. Moreover, the several components of the hardware environment may be distributed among those locations. The input device 420 may be any data reader or user input device, such as data card reader, keyboard, USB port, etc. The information storage medium 410 stores information provided by the detectors. Information storage medium 410 may include any non-transitory computer-readable medium for standard computer information storage, such as a USB drive, memory stick, hard disk, removable RAM, EPROMs, EAROMs, flash memories and optical disks or other commonly used memory storage system known to one of ordinary skill in the art including Internet based storage. Information storage medium 410 stores a program that when executed causes information processor 400 to execute the disclosed method. Information storage medium 410 may also store the formation information provided by the user, or the formation information may be stored in a peripheral information storage medium 440, which may be any standard computer information storage device, such as a USB drive, memory stick, hard disk, removable RAM, or other commonly used memory storage system known to one of ordinary skill in the art including Internet based storage. Information processor 400 may be any form of computer or mathematical processing hardware, including Internet based hardware. When the program is loaded from information storage medium 410 into processor memory 430 (e.g. computer RAM), the program, when executed, causes information processor 400 to retrieve detector information from either information storage medium 410 or peripheral information storage medium 440 and process the information to estimate a parameter of interest. Information processor 400 may be located on the surface or downhole.

While the foregoing disclosure is directed to the one mode embodiments of the disclosure, various modifications will be apparent to those skilled in the art. It is intended that all variations be embraced by the foregoing disclosure.

We claim:

1. A method for using a sensor to acquire information, comprising:
moving the sensor to at least two different orientations,
wherein the sensor has an initial orientation; and
calibrating the sensor with a linear model using information acquired from the initial orientation and the at least two different orientations, wherein the information includes a response by the sensor to earth gravity and an external force.

2. The method of claim 1, wherein the linear model includes a gain factor and an offset.

3. The method of claim 2, wherein the gain factor is determined based on the application of the external force.

4. The method of claim 3, wherein the external force is approximately 0.01 to 0.001 times the force of earth gravity.

5. The method of claim 2, wherein the offset is determined based on sensor information obtained from the initial orientation and the at least two different orientations.

6. The method of claim 2, wherein the offset is estimated using a solution to one of: a second order equation and a trigonometric equation.

7. The method of claim 1, wherein the sensor is positioned in a wellbore during the calibration.

8. The method of claim 1, wherein the initial orientation and the at least two different orientations are perpendicular to a sensitive axis.

9. The method of claim 1, wherein the sensor is one of: (i) a relative gravimeter, (ii) an accelerometer, (iii) a magnetometer, and (iv) an electric field meter.

10. The method of claim 1, further comprising:
acquiring information using the calibrated sensor.

11. An apparatus for acquiring information using a sensor, comprising:
a processor;
a non-transitory computer-readable medium; and
a program stored by the non-transitory computer-readable medium comprising instructions that,
when executed, cause the processor to:
move the sensor to at least two different orientations,
estimate a gain factor based on information acquired from an initial orientation of the sensor and the at least two different orientations, wherein the information includes a response by the sensor to earth gravity and an external force, and
estimate an offset based on information acquired from an initial orientation of the sensor and the at least two different orientations.

12. The apparatus of claim 11, wherein the program further comprises instructions that, when executed, cause the processor to:
apply the external force to the sensor.

13. The apparatus of claim 11, wherein the external force is approximately 0.01 to 0.001 times the force of earth gravity.

14. The apparatus of claim 11, wherein the offset is estimated using a solution to one of: a second order equation and a trigonometric equation.

15. The apparatus of claim 11, wherein the sensor is positioned in a wellbore.

16. The apparatus of claim 11, wherein the initial orientation and the at least two different orientations are perpendicular to a sensitive axis.

17. The apparatus of claim 11, wherein the program further comprises instructions that, when executed, cause the processor to:
acquire information using the sensor and a model including the gain factor and the offset.
